(19) United States
(12) Patent Application Publication
(10) Pub. No.: US 2008/0160242 A1
(43) Pub. Date: Jul. 3, 2008

(54) DOUBLE SIDED ACRYLIC ADHESIVE TAPES AND THEIR USAGE

(75) Inventor: HOJIN CHOI, WINDSOR, CT (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: SCAPA TAPES NORTH AMERICA, WINDSOR, CT (US)

(21) Appl. No.: 11/829,427

(22) Filed: Jul. 27, 2007

(30) Foreign Application Priority Data
Dec. 27, 2006 (KR) 10-2006-0134778

(51) Int. Cl. B32B 33/00

(52) U.S. Cl. 428/41.8

(57) ABSTRACT

The present disclosure provides a double sided acrylic foam tape having a base layer and a double sided acrylic foam tape using the same, for mobile phone use. Specifically, the present disclosure provides a double sided acrylic foam tape, comprising: an acrylic foam layer with a certain thickness; a base layer formed on either side of the acrylic foam layer; a pressure sensitive adhesive layer formed on one side of the base layer; and a release film formed on the pressure sensitive adhesive layer.

### RELATED APPLICATION

This application claims the benefit of and priority to Korean Patent Application No. 10-2006-0134778, filed Dec. 27, 2006, the contents of which are incorporated by reference herein in its entirety.

### BACKGROUND

1. Field

The present disclosure relates to a double sided acrylic foam tape, specifically to a double sided acrylic foam tape having a base layer and a double sided acrylic foam tape for mobile phone use, using the same.

2. General Background

FIG. 1 is a cross-sectional view of a conventional acrylic foam tape (10). As shown in FIG. 1, the conventional acrylic foam tape (10) is comprised of an acrylic foam layer (12) at a certain thickness and a release film (14).

Such conventional acrylic foam tape (10) has a high elongation rate so that it has a tendency to get easily elongated, during a die-cutting or punching process for forming such tape to a desired shape or size. Therefore, it has a bad processability, disadvantageously. Once a conventional acrylic foam tape (10) is attached to a product, if it is detached therefrom or modified, it is frequently occurred that the acrylic foam is so elongated that it does not fit to the product size, or broken so that it cannot be used again.

### SUMMARY

The present disclosure has been designed to solve the above-mentioned problems of the conventional arts. Therefore, the present disclosure provides a double sided acrylic foam tape having a base layer, a method thereof and a double sided acrylic foam tape for mobile phone use, using the same, which can make it possible to easily conduct a die-cutting or punching process according to the product size, by using a base layer in an acrylic foam tape.

In addition, the present disclosure provides a double sided acrylic foam tape having a base layer, a method thereof and a double sided acrylic foam tape for mobile phone use, using the same, wherein a different level of adhesiveness can be imparted, or colors, perfume, or the like can be added to each side of the acrylic foam tape.

Other objects, advantages and characteristics of the present disclosure may become more obvious by the detailed description and exemplary embodiments of the present disclosure as follows, with referencing to the attached drawings.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a cross-sectional view of a conventional acrylic foam tape (10);

FIG. 2 is a cross-sectional view of a double sided acrylic foam tape having a base layer (20) according to a first embodiment of the present disclosure;

FIG. 3 is a cross-sectional view of a double sided acrylic foam tape having a base layer (30) according to a second embodiment of the present disclosure;

FIG. 4 is a cross-sectional view of a double sided acrylic foam tape having a base layer (40) according to a third embodiment of the present disclosure;

FIG. 5 is a cross-sectional view of a double sided acrylic foam tape having a base layer (50) according to a fourth embodiment of the present disclosure;

FIG. 6 is a cross-sectional view of a double sided acrylic foam tape having a base layer (60) according to a fifth embodiment of the present disclosure; and

FIG. 7 is a disassembled perspective view showing a double sided acrylic foam tape for mobile phone use according to the present disclosure and a mobile phone (100).

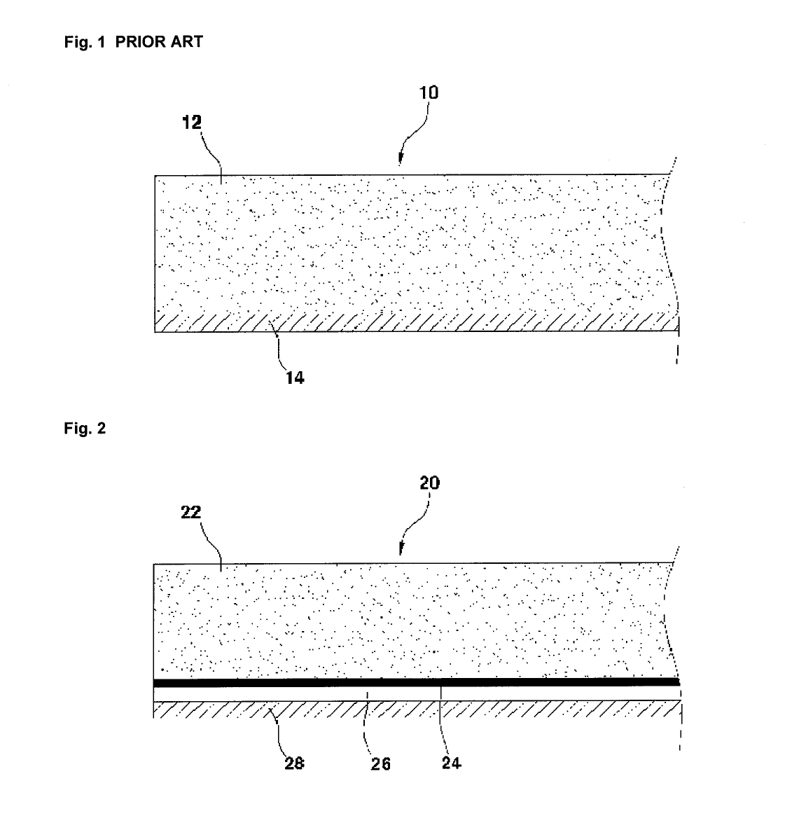

### NUMERALS USED IN MAIN PARTS OF THE DRAWINGS

10: acrylic foam tape,
12: acrylic foam layer,
14: release film,
20: double sided acrylic foam tape having a base layer,
22: acrylic foam layer,
24: base layer,
26: pressure sensitive adhesive layer,
28: release film,
30: double side acrylic foam tape having a base layer,
32: acrylic foam layer,
34: base layer,
36: second pressure sensitive adhesive layer,
37: first pressure sensitive adhesive layer,
38: release film,
40: double sided acrylic foam tape having a base layer,
42: first acrylic foam layer,
43: second acrylic foam layer,
44: base layer,
48: release film,
50: double sided acrylic foam tape having a base layer,
52: first acrylic foam layer,
53: second acrylic foam layer,
54: base layer,
56: pressure sensitive adhesive layer,
58: release film,
60: double sided acrylic foam tape having a base layer,
62: first acrylic foam layer,
63: second acrylic foam layer,
64: base layer,
66: second pressure sensitive adhesive layer,
67: first pressure sensitive adhesive layer,
68: release film,
100: mobile phone,
120: cover part,
125: display part,
150: key pad part,
160: through-hole,
170: protection film.

### DETAILED DESCRIPTION

The forgoing objects of the present disclosure can be achieved by a double sided acrylic foam tape having a base layer, comprising: an acrylic foam layer with a certain thickness; a base layer formed on either side of the acrylic foam layer; a pressure sensitive adhesive layer formed on one side of the base layer; and a release film formed on the pressure sensitive adhesive layer.

The thickness of the acrylic foam layer is 0.01 mm˜4 mm. When the thickness is too thin, the strength of a base layer becomes low, while it is too thick, a die-cutting process can be difficult to achieve.

As another modified embodiment, the pressure sensitive adhesive layer is a second pressure sensitive adhesive layer, and the other side of the acrylic foam layer may further comprise a first pressure sensitive adhesive layer.

The first pressure sensitive adhesive layer may be any one selected from the group consisting of those transparent, semi-transparent, opaque and added with a perfume.

Further, the tape of the present disclosure can be also achieved by a double sided acrylic foam tape having a base layer, characterized by comprising: a first acrylic foam layer with a certain thickness; a base layer formed on one side of the first acrylic foam layer; a second acrylic foam layer formed on one side of the base layer; and a release film formed on the second acrylic foam layer.

The other side of the first acrylic foam layer may further comprise a pressure sensitive adhesive layer.

Further, in exemplary embodiments, the pressure sensitive adhesive layer is the first pressure sensitive adhesive layer, and a second pressure sensitive adhesive layer is further inserted between a second acrylic foam layer and a release film.

Further, the tape of the present disclosure can be achieved by a double sided acrylic foam tape having a base layer for mobile phone use, which comprises a double sided acrylic foam tape having a base layer as described above, and has a through-hole formed in a way that one side of the double sided acrylic foam tape having a base layer is attached to the surround of a display part in the mobile phone, and the other side thereof is attached to a protection film (170).

The through-hole has a square shape, and formed by a die-cutting process.

Hereinafter, the present disclosure is further described in detail, referencing the drawings attached hereto which illustrate exemplary embodiments of the present disclosure.

### EXAMPLE 1

FIG. 2 is a cross-sectional view of a double sided acrylic foam tape (20) having a base layer (PET layer) according to a first embodiment of the present disclosure. As it is shown in FIG. 2, a base layer (24) is provided under the lower surface of an acrylic foam layer (22) having a thickness of 0.1 mm˜4 mm, and under the base layer (24), a pressure sensitive adhesive layer (26) is provided. Under the pressure sensitive adhesive layer (26), a release film (28) is provided. Since the acrylic foam layer (22) itself also has self-adhesiveness, it functions as a double sided tape. The acrylic foam layer (22) further serves as an impact absorbing layer owing to its cushioning effect against outside impact.

Hereinafter, a method for preparing a double sided acrylic foam tape having a base layer (20) according to the first embodiment of the present disclosure is described. Firstly, an acrylic foam precursor composition is prepared by using functional acrylate monomers such as acrylic acid, and major monomers such as 2-ethylhexylacrylate, butyl, isoocthyl, ethyl and methyl, while adding a small amount of a photoinitiator. An inert gas such as argon and nitrogen is blown into the resulted mixture, and then polymerization is induced by, for example, UV, resulting in partially polymerized syrup which is slightly viscous. As for the inert gas used herein, a nitrogen gas is utilized in exemplary cost effective embodiments. The partial polymerization can be conducted by thermal polymerization without being specifically limited to polymerization induced by irradiation.

The acrylic foam precursor composition has a viscosity of 100-20,000 cps, particularly 1,000˜3,000 cps (Brookfield Viscosity) at an operation temperature of a mixing device, for example at 25° C. The acrylic foam composition may comprise multi-functional monomers such as 2,4-hexadecadienoic acid in a small amount. The acrylic foam composition may be obtained by adding other optional components, as it is required for the syrup obtained from the partial polymerization. For other desired characteristics, fillers in the form of a foam, gas foams, thickeners, perfumes, color pigments, plasticizers, anti-oxidants, resins which can impart adhesiveness, or the like may be mixed together for suitable use. After coating the acrylic foam composition over a base, additional polymerization is carried out for hardening, resulting in an acrylic foam adhesive. As for a base used herein, plastic films such as a film made of polyethylene terephthalate (PET) treated with corona may be used.

Specifically, a mixture of 90 parts by weight (pts·wt) of 2-ethylhexylacrylate, 10 pts·wt of acrylic acid, and 0.05 pts·wt of Micure CP4 (Micure Miwon Commercial Co., Ltd.) is maintained under nitrogen atmosphere for 1 hour. Then, the mixture is irradiated with UV having a wavelength in the range of 300˜400 nm at the intensity of 1˜3 mW for 5˜10 minutes, so as to conduct partial polymerization thereof, resulting in syrup having a viscosity of 1,000˜3,000 Pa-s. To the resulted syrup, 0.5 pts·wt of Micure CP4, 1 pts·wt of Microbubble and 0.05 pts·wt of SR-213 1,4-Butanediol diacrylate (BDDA) are added with stirring. The resulted mixture was deaerated by a vacuum pump, obtaining an acrylic foam precursor composition. By irradiating the resulted composition with 0.5˜7 mW UV for 6 minutes, the composition is cured and results in a single sided PET acrylic foam tape. To the PET side of the resulted acrylic foam tape, a pressure sensitive adhesive layer (26) is coated so as to form a double sided acrylic foam tape (20).

Test results of physical properties of the double sided acrylic foam tape (20) as prepared above, are represented in the following tables.

Firstly, Table 1 shows tensile strength and elongation rate of general low density polyethylene (LDPE) and polypropylene (PP) with different thicknesses.

TABLE 1

| | Tensile strength | Elongation rate |
|---|---|---|
| 60 micron | 12.6 | 200.0 |
| LDPE | 12.3 | 240.4 |
| 65 micron | 13.8 | 338.2 |
| LDPE | 13.8 | 287.7 |
| 65 micron | 59.1 | 23.1 |
| PP | 64.6 | 31.8 |
| | 49.1 | 13.2 |

Table 2 shows tensile strength and elongation rate of general PET (polyethylene terephthalate) with different thicknesses.

TABLE 2

| | Tensile strength | Elongation rate |
|---|---|---|
| 100 micron PET | 299.6 | 48.4 |
| | 296.2 | 46.8 |
| | 305.0 | 58.0 |
| 80 micron PET | 211.8 | 37.3 |
| | 212.8 | 39.4 |
| | 217.1 | 38.7 |
| 75 micron PET | 228.2 | 25.7 |
| | 241.4 | 35.2 |
| | 234.6 | 28.9 |
| 50 micron PET | 175.2 | 26.5 |
| | 160.0 | 21.5 |
| | 165.6 | 23.5 |
| 38 micron PET | 120.5 | 18.4 |
| | 117.3 | 16.2 |
| | 122.7 | 17.9 |
| 25 micron PET | 73.9 | 9.5 |
| | 73.8 | 9.8 |
| | 73.9 | 10.2 |
| 12 micron PET | 11.5 | 3.9 |
| | 13.4 | 4.1 |
| | 8.9 | 5.7 |

Table 3 shows the test results of tensile strength and elongation rate of other materials which could be used as a base.

TABLE 3

| | Tensile strength | Elongation rate |
|---|---|---|
| 25 micron copper | 228.5 | 4.2 |
| | 225.9 | 3.8 |
| 100 micron paper | 134.5 | 2.4 |
| | 150.6 | 2.8 |
| 65 mesh fabric | 54.2 | 29.2 |
| | 52.7 | 28.5 |

Table 4 shows the species and thicknesses of materials which can be used as a base, owing to their great tensile strength, and small elongation rate.

TABLE 4

| Base materials | Species | Thickness |
|---|---|---|
| Metal foils | Aluminum | 12-200 microns |
| | Copper | |
| | Zinc | |
| | SUS | |
| | Steel | |
| | Etc. | |
| Polyolefin films | PET | 9-125 microns |
| | PP | |
| | PE | |
| | Etc. | |
| PU film | — | 12-200 microns |
| Paper | — | 10-150 microns |
| Fabric | 42-200 mesh | — |

Table 5 shows the species and thicknesses of pressure sensitive adhesives.

TABLE 5

| Species | Thickness |
|---|---|
| UV Polymerized PSA | 0.01-4 mm |
| EB polymerized PSA | 0.01-0.15 mm |
| Solvent acrylic PSA | |
| Rubber PSA | |
| Emulsion acrylic PSA | |
| Silicon PSA | |

Table 6 shows the test results of physical properties of a general double sided acrylic foam tape and a PET acrylic foam tape according to the present disclosure, for comparison.

TABLE 6

| | Tensile strength | Elongation rate |
|---|---|---|
| General double sided acrylic | 6.1 | 1017 |
| foam tape | 6.4 | 980 |
| PET acrylic foam tape of the | 122.9 | 59.4 |
| present disclosure | 125.4 | 61.2 |

As it can be seen from table 6, the double sided acrylic foam tape which has a PET layer as a base layer according to the present disclosure has superior tensile strength to that of general double sided acrylic foam tape. As for the elongation rate, the present disclosure has a very small value. It means that, when the double sided acrylic foam tape according to the present disclosure is detached, transformation of the tape can be minimized owing to the base layer, and size processing thereof, for example die-cutting or punching can be easily done.

### EXAMPLE 2

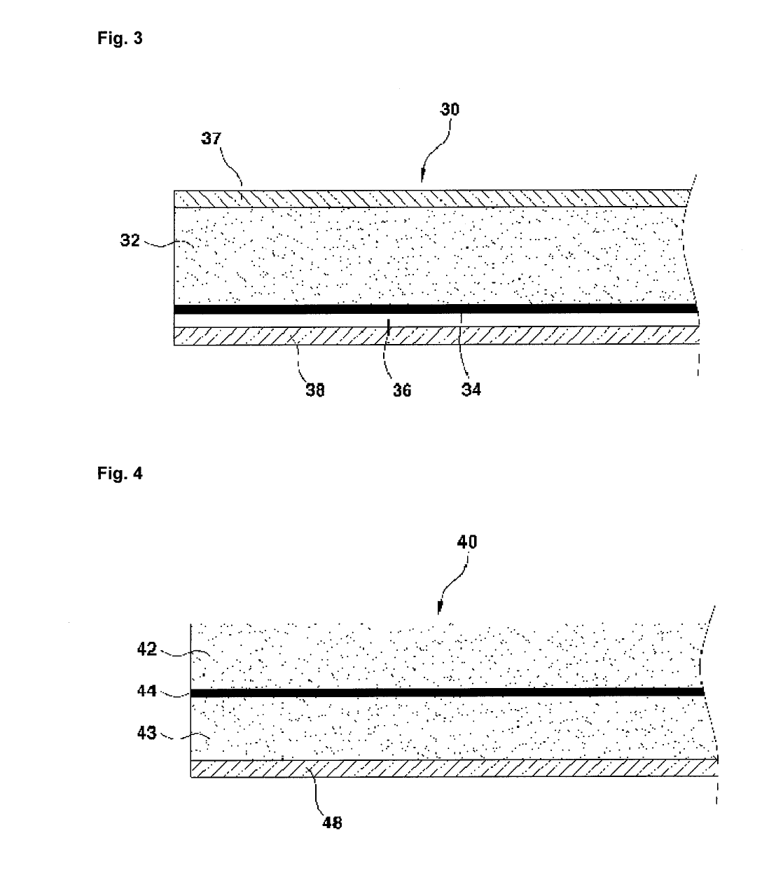

FIG. 3 is a cross-sectional view of a double sided acrylic foam tape having a base layer (30) according to a second embodiment of the present disclosure. As it is shown in FIG. 3, a base layer (34) is provided under the lower surface of an acrylic foam layer (32) having a thickness of 0.1 mm˜4 mm, and under the base layer (34), a second pressure sensitive adhesive layer (36) is provided. Under the second pressure sensitive adhesive layer (36), a release film (38) is provided. In order to achieve stronger adhesiveness, a first pressure sensitive adhesive layer (37) is provided on the upper surface of the acrylic foam layer (32). The first pressure sensitive adhesive layer (37), if necessary, can be mixed with colors (semi-transparent, red, grey or the like), or added with perfumes (for example, fruits, pine tree, herb or the like).

The preparation method of the double sided acrylic foam tape (30) illustrated in FIG. 3 is similar with the method described in the forgoing Example 1, thus eliminating the detailed description of the preparation method herein.

### EXAMPLE 3

FIG. 4 is a cross-sectional view of a double sided acrylic foam tape having a base layer (40) according to a third embodiment of the present disclosure. As it is shown in FIG. 4, a base layer (44) is provided under the lower surface of a first acrylic foam layer (42) having a thickness of 0.2 mm˜0.6 mm, and under the base layer (44), a second acrylic foam layer (43) is provided. Under the second acrylic foam layer (43), a release film (48) is provided.

The preparation method of the double sided acrylic foam tape (40) illustrated in FIG. 4 is similar with the method described in the forgoing Example 1, thus eliminating the detailed description of the preparation method herein.

### EXAMPLE 4

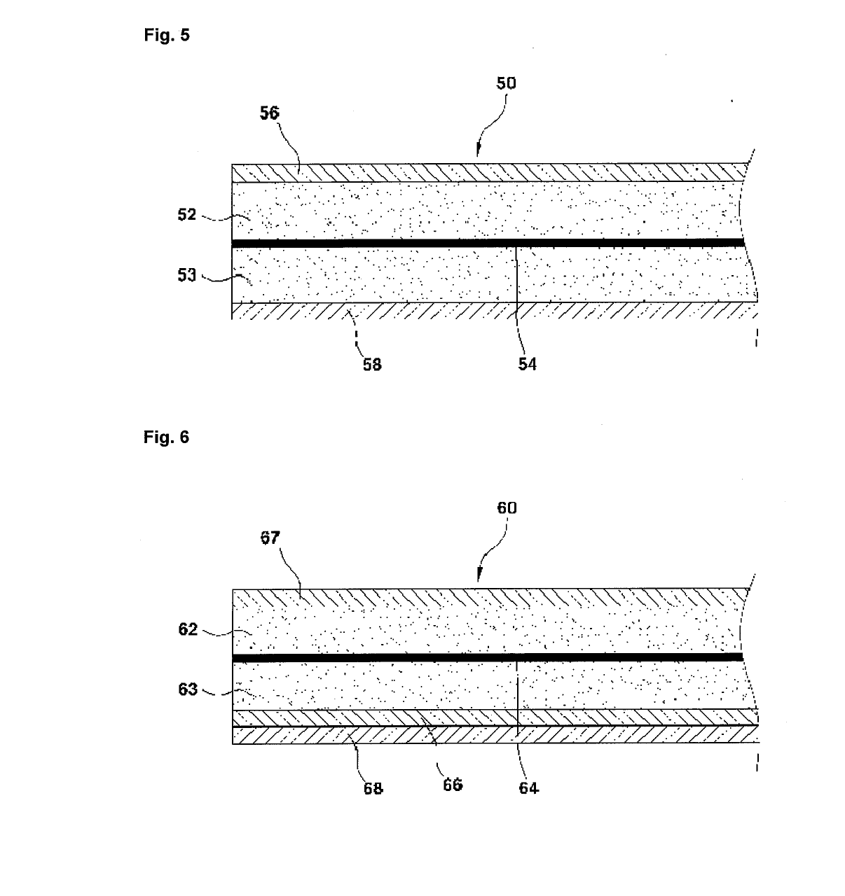

FIG. 5 is a cross-sectional view of a double sided acrylic foam tape having a base layer (50) according to a fourth embodiment of the present disclosure. As it is shown in FIG. 5, a base layer (54) is provided under the lower surface of a first acrylic foam layer (52) having a thickness of 0.2 mm˜0.6 mm, and under the base layer (54), a second acrylic foam layer (53) is provided. Under the second acrylic foam layer (53), a release film (58) is provided. In order to achieve stronger adhesiveness, a pressure sensitive adhesive layer (56) is provided on the upper surface of the first acrylic foam layer (52).

The preparation method of the double sided acrylic foam tape (50) illustrated in FIG. 5 is similar with the method described in the forgoing Example 1, thus eliminating the detailed description of the preparation method herein.

### EXAMPLE 5

FIG. 6 is a cross-sectional view of a double sided acrylic foam tape having a base layer (60) according to a fifth embodiment of the present disclosure. As it is shown in FIG. 6, a base layer (64) is provided under the lower surface of a first acrylic foam layer (62) having a thickness of 0.2 mm˜0.6 mm, and under the base layer (64), a second acrylic foam layer (63) is provided. Under the second acrylic foam layer (63), a second pressure sensitive adhesive layer (66), and thereunder a release film (68) are provided. In order to achieve stronger adhesiveness, a first pressure sensitive adhesive layer (67) is provided on the upper surface of the first acrylic foam layer (62).

The preparation method of the double sided acrylic foam tape (60) illustrated in FIG. 6 is similar with the method described in the forgoing Example 1, thus eliminating the detailed description of the preparation method herein.

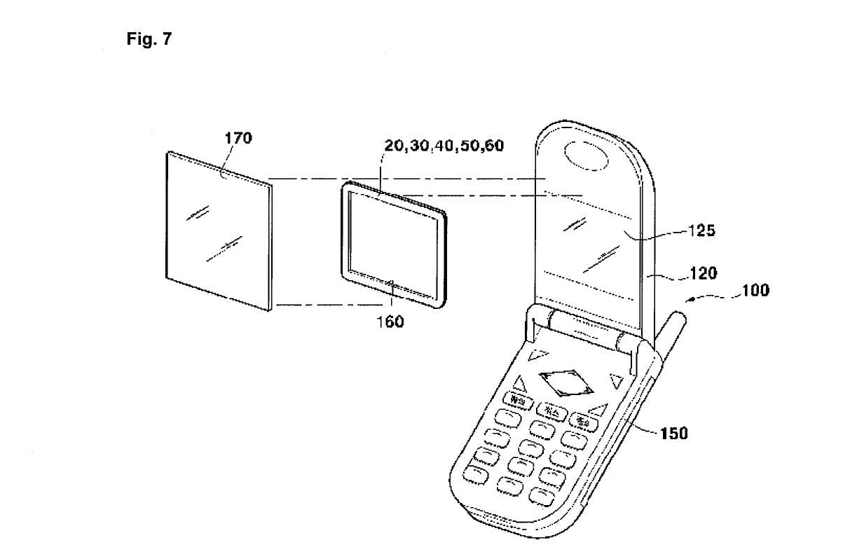

Hereinafter, specific application examples of double sided acrylic foam tapes as described in the forgoing examples 1-5 are described. FIG. 7 is a disassembled perspective view of a double sided acrylic foam tape for mobile phone use according to the present disclosure and a mobile phone (100). As it is disclosed in FIG. 7, the mobile phone (100) is comprised of a key pad part (150) having key pads and an operation part, and a cover part (120) having a display part (125).

Particularly, on the cover part (120), a display part (125) such as LCD or OLED is located. For protecting the display part (125), a transparent protection film (170) is attached over the surface of the display part (125). The protection film (170) is to prevent the display part from scratches and infiltration of impurities such as humidity or dust.

The double sided acrylic foam tape (20, 30, 40, 50, 60) according to the present disclosure is placed between the display part (125) and the protection film (170), so as to strongly bond the protection film (170) to the cover part (120). For achieving this, the double sided acrylic foam tape (20, 30, 40, 50, 60) has a square hole in its center so as to be attached to the surround of the display part (125), and each corner of the tape is rounded.

For forming the double sided acrylic foam tape (20, 30, 40, 50, 60) according to the present disclosure to the above-mentioned shape, it is subjected to a die-cutting process. Owing to the base layer inserted therein, it is possible to easily conduct the die-cutting thereof to form the shape as shown in FIG. 7. Further, the shape of the double sided acrylic foam tape (20, 30, 40, 50, 60) is not greatly transformed, which means it has smaller elongation rate, so that it can be attached to the mobile phone (100) as it is. When it is used in a mobile phone (100), the adhesiveness of each side of the double sided acrylic foam tape (20, 30, 40, 50, 60) can be easily controlled by selectively carrying out one of the forgoing examples 15.

### INDUSTRIAL APPLICABILITY

According to the forgoing embodiments of the present disclosure, it becomes possible to easily carry out die-cutting or punching or the like according to the product size, by using a base layer in an acrylic foam tape. Therefore, the present disclosure provides an advantage of expanding the application range of such tape by processing the tapes to have various shapes.

In addition, it is also possible to provide a different level of adhesiveness for each side of an acrylic foam tape, or to add perfumes, thereby meeting the needs of consumers and improving the product value.

Although the present disclosure has been described with related to the exemplary embodiments of the present disclosure, it should be understood that various modifications and variations can be made to the present disclosure, without departing from the concept and scope of the present disclosure, by persons skilled in the art, and it is obvious that such modifications and variations fall within the protection range of the present disclosure as represented in the attached claims.

While the apparatus and method have been described in terms of what are presently considered to be the most practical and exemplary embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A double sided acrylic foam tape, comprising:
an acrylic foam layer with a certain thickness;
a base layer formed on either side of the acrylic foam layer;
a pressure sensitive adhesive layer formed on one side of the base layer; and
a release film formed on the pressure sensitive adhesive layer.

2. The double sided acrylic foam tape according to claim 1, wherein the acrylic foam layer has a thickness in the range of 0.01 mm˜4 mm.

3. The double sided acrylic foam tape according to claim 1, wherein the pressure sensitive adhesive layer is a second pressure sensitive adhesive layer, and the other side of the acrylic foam layer further comprises a pressure sensitive adhesive layer.

4. The double sided acrylic foam tape according to claim 3, wherein the first pressure sensitive adhesive layer is any one selected from the group consisting of those transparent, semi-transparent, opaque and added with a perfume.

5. A double sided acrylic foam tape, comprising:
a first acrylic foam layer with a certain thickness;
a base layer formed on one side of the first acrylic foam layer;
a second acrylic foam layer formed on one side of the base layer; and
a release film formed on the second acrylic foam layer.

6. The double sided acrylic foam tape according to claim 5, wherein the other side of the first acrylic foam layer further comprises a pressure sensitive adhesive layer.

7. The double sided acrylic foam tape according to claim 6, wherein the pressure sensitive adhesive layer is a first pressure sensitive adhesive layer, and a second pressure sensitive adhesive layer is further inserted between the second acrylic foam layer and the release film.

8. The double sided acrylic foam tape according to claim 7, wherein the first pressure sensitive adhesive layer is any one selected from the group consisting of those transparent, semi-transparent, opaque and added with a perfume.

9. The double sided acrylic foam tape according to claim 1, for mobile phone use, wherein the base layer is any one selected from the group consisting of a PET layer, paper, fabric, metal foil and polyolefin.

10. The double sided acrylic foam tape according to claim 1 for mobile phone use, and has a through-hole formed in a way that one side of the double sided acrylic foam tape is attached to the surround of a display part in the mobile phone, and the other side thereof is attached to a protection film.

11. The double sided acrylic foam tape for mobile phone use according to claim 10, wherein the through-hole has a square shape.

12. The double sided acrylic foam tape for mobile phone use according to claim 10, wherein the through-hole is formed by a die-cutting process.
